(19) United States
(12) Patent Application Publication
(10) Pub. No.: US 2022/0276402 A1
(43) Pub. Date: Sep. 1, 2022

(54) SEISMIC OBSERVATION DEVICE, SEISMIC OBSERVATION METHOD, AND RECORDING MEDIUM FOR RECORDING SEISMIC OBSERVATION PROGRAM

(71) Applicants: NEC CORPORATION, Tokyo (JP); JAPAN AGENCY FOR MARINE-EARTH SCIENCE AND TECHNOLOGY, Yokosuka-shi, Kanagawa (JP)

(72) Inventors: Naoki KUWAMORI, Tokyo (JP); Narumi TAKAHASHI, Yokosuka-shi (JP); Masaru NAKANO, Yokosuka-shi (JP); Kentaro SUEKI, Yokosuka-shi (JP); Shuichiro YADA, Yokosuka-shi (JP); Yoko KUMAMORI, Yokosuka-shi (JP)

(73) Assignees: NEC CORPORATION, Tokyo (JP); JAPAN AGENCY FOR MARINE-EARTH SCIENCE AND TECHNOLOGY, Yokosuka-shi, Kanagawa (JP)

(21) Appl. No.: 17/631,550

(22) PCT Filed: Jul. 28, 2020
(86) PCT No.: PCT/JP2020/028863

§ 371 Date: Jan. 31, 2022

(30) Foreign Application Priority Data
Aug. 20, 2019 (JP) 2019-150631

(51) Int. Cl. G01V 1/30

(52) U.S. Cl. CPC G01V 1/307

(57) ABSTRACT

A seismic observation device includes a vibration detection status information acquisition that acquires vibration detection status information at each of a plurality of observation points, a multidimensionalization unit that generates vibration detection status information in two or more dimensions related to a geographical position and a time on the basis of the vibration detection status information at each of the plurality of observation points, and a group specifying unit that classifies element information that forms the vibration detection status information in two or more dimensions and each piece of which indicates a vibration detection status at a certain geographical position and a certain time into groups for each cause of vibration.

### TECHNICAL FIELD

The present invention relates to a seismic observation device, a seismic observation method, and a recording medium for recording a seismic observation program.

### BACKGROUND ART

For seismic observation, seismographs are installed at a plurality of locations and a seismic intensity is measured at each location (for example, Patent Document 1).

### PRIOR ART DOCUMENTS

### Patent Documents

### [Patent Document 1]

Japanese Unexamined Patent Application, First Publication No. 2016-156712

### SUMMARY OF INVENTION

### Problems to be Solved by the Invention

In a case where a plurality of earthquakes have occurred in close proximity in time and position, it is necessary to obtain a correspondence relationship between an observed vibration and an earthquake that has caused the vibration in order to predict the hypocenter of each earthquake. In order to obtain this correspondence relationship with high accuracy, it is preferable that not only positional relationships of observation points but also a relatively large amount of information can be used.

An object of the present invention is to provide a seismic observation device, a seismic observation method, and a recording medium for recording a seismic observation program, capable of solving the above problems.

### Means for Solving the Problems

According to a first aspect of the present invention, there is provided a seismic observation device including vibration detection status information acquisition means for acquiring vibration detection status information at each of a plurality of observation points; multidimensionalization means for generating vibration detection status information in two or more dimensions related to a geographical position and a time on the basis of the vibration detection status information at each of the plurality of observation points; and group specifying means for classifying element information that forms the vibration detection status information in two or more dimensions and each piece of which indicates a vibration detection status at a certain geographical position and a certain time into groups for each cause of vibration.

According to a second aspect of the present invention, there is provided a seismic observation method including acquiring vibration detection status information at each of a plurality of observation points; generating vibration detection status information in two or more dimensions related to a geographical position and a time on the basis of the vibration detection status information at each of the plurality of observation points; and classifying element information that forms the vibration detection status information in two or more dimensions and each piece of which indicates a vibration detection status at a certain geographical position and a certain time into groups for each cause of vibration.

According to a third aspect of the present invention, there is provided a recording medium for recording a seismic observation program causing a computer to acquire vibration detection status information at each of a plurality of observation points; generate vibration detection status information in two or more dimensions related to a geographical position and a time on the basis of the vibration detection status information at each of the plurality of observation points; and classify element information that forms the vibration detection status information in two or more dimensions and each piece of which indicates a vibration detection status at a certain geographical position and a certain time into groups for each cause of vibration.

### Advantageous Effects of the Invention

According to the present invention, a relatively large amount of information can be used to obtain a correspondence relationship between an observed vibration and an earthquake that has caused the vibration.

### BRIEF DESCRIPTION OF DRAWINGS

FIG. 1 is a block diagram illustrating an example of a functional configuration of a seismic observation device according to an embodiment.

FIG. 2 is a block diagram illustrating an example of a functional configuration of a seismic processing system according to the embodiment.

FIG. 3 is a graph illustrating a disposition example of observation points disposed linearly according to the embodiment.

FIG. 4 is a graph illustrating an example of two-dimensional trigger detection status information generated by using observation points disposed linearly according to the embodiment.

FIG. 5 is a graph illustrating an example of trigger detection status information in two or more dimensions in an encoding method according to the embodiment.

FIG. 6 is a graph illustrating an example of a trigger group determined by a group specifying unit according to the embodiment.

FIG. 7 is a block diagram illustrating an example of a functional configuration of a model generation device according to the embodiment.

FIG. 8 is a block diagram illustrating a seismic observation device according to an embodiment of the minimum configuration of the present invention.

FIG. 9 is a flowchart illustrating a processing procedure in a seismic observation method according to the embodiment of the minimum configuration of the present invention.

FIG. 10 is a block diagram illustrating a configuration of a computer according to at least one of the above embodiments.

### EXAMPLE EMBODIMENTS

Hereinafter, embodiments of the present invention will be described, but the following embodiments do not limit the invention according to the claims. Not all combinations of features described in the embodiments are essential to solving means of the invention.

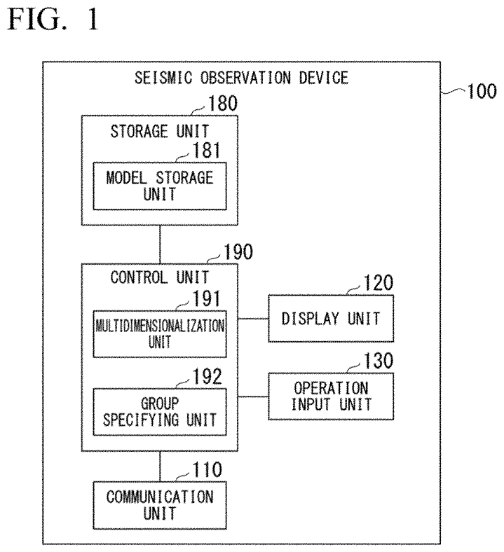

FIG. 1 is a schematic block diagram illustrating an example of a functional configuration of a seismic observation device according to the embodiment. As illustrated in FIG. 1, a seismic observation device 100 includes a communication unit 110, a display unit 120, an operation input unit 130, a storage unit 180, and a control unit 190. The storage unit 180 includes a model storage unit 181. The control unit 190 includes a multidimensionalization unit 191 and a group specifying unit 192.

The seismic observation device 100 groups vibrations observed at a plurality of respective observation points according to each of events that has caused the vibrations. In particular, the seismic observation device 100 groups vibrations shown as triggers on data in two or more dimensions having spreads in the time direction and the spatial direction for each of events that has caused the vibrations.

The seismic observation device 100 is configured by using a computer such as a workstation or a mainframe.

The above observation point is a point where a sensor for observing shaking (vibration) such as an earthquake is installed. The observation point will also be referred to as a seismic observation point or a seismic intensity observation point. A vibration measured by a sensor at the observation point will also be referred to as a vibration at the observation point.

The above event is a cause of vibration (event that causes vibration) such as an earthquake.

For example, in a case where two earthquakes occur in close proximity in time and position, it is necessary to specify which earthquake causes a vibration observed at each observation point in order to predict the hypocenter of each of the two earthquakes. If this specifying accuracy is low, information used to predict the hypocenter will include information regarding another earthquake. The information of this other earthquake serves as noise, and thus the estimation accuracy of the hypocenter is reduced. Thus, it is desirable that the seismic observation device 100 performs grouping for each vibration event with high accuracy.

The trigger is a vibration different from a normal vibration (for example, a vibration of which a level is equal to or lower than a noise level) generated in daily life. When the seismic observation device 100 detects a vibration different from the normal vibration, the seismic observation device 100 performs a process for seismic observation on the vibration. In this respect, the vibration different from the normal vibration is a trigger for the seismic observation device 100 to perform the process for seismic observation.

Determining the presence or absence of the vibration different from the normal vibration will also be referred to as determining a trigger.

Information indicating a trigger detection status, such as the presence or absence of trigger detection, will be referred to as trigger detection status information. The trigger detection status information corresponds to an example of vibration detection status information.

The seismic observation device 100 can be used to predict the hypocenter of an earthquake.

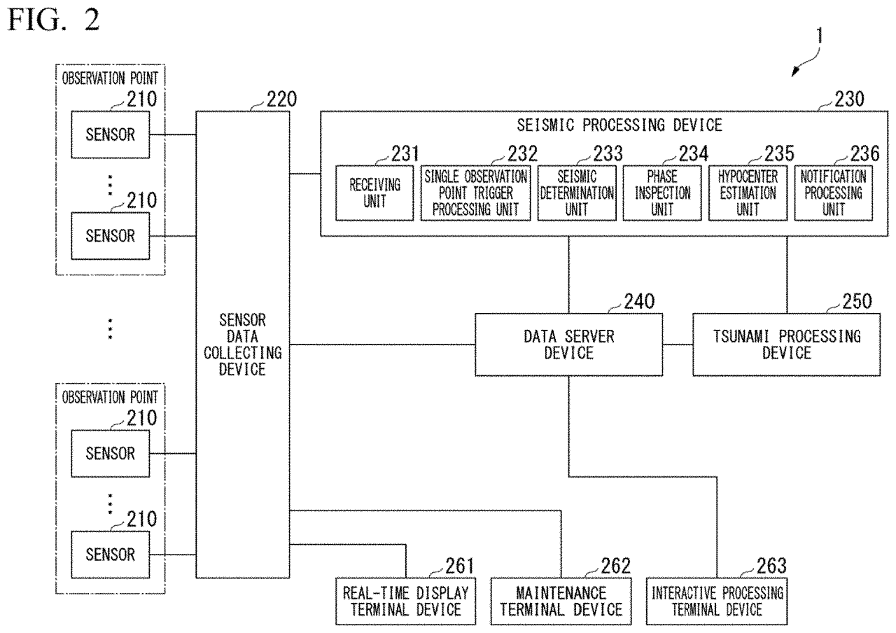

FIG. 2 is a schematic block diagram illustrating an example of a functional configuration of a seismic processing system according to the embodiment. In the configuration illustrated in FIG. 2, a seismic processing system 1 includes a sensor 210, a sensor data collecting device 220, a seismic processing device 230, a data server device 240, a tsunami processing device 250, a real-time display terminal device 261, a maintenance terminal device 262, and an interactive processing terminal device 263. The seismic processing device 230 includes a receiving unit 231, a single observation point trigger processing unit 232, a seismic determination unit 233, a phase inspection unit 234, a hypocenter estimation unit 235, and a notification processing unit 236.

The seismic processing device 230, the tsunami processing device 250, and the data server device 240 are configured by using a computer such as a workstation or a mainframe.

The seismic processing system 1 reports a seismic early warning when an earthquake occurs. In the seismic processing system 1, the sensor data collecting device 220 collects measurement data from the sensor 210 installed at the observation point, transmits the collected data to the seismic processing device 230, and registers the collected data in the data server device 240.

The seismic processing device 230 determines whether or not an earthquake has occurred based on the measurement data of the sensor 210. In a case where it is determined that an earthquake has occurred, the seismic processing device 230 predicts the hypocenter (seismic center) and notifies a notification destination of an estimation result together with tsunami information from the tsunami processing device 250. The notification destination here may be, for example, a terminal device of a person in charge of seismic analysis, or an organization that reports seismic information such as a television station.

The receiving unit 231 receives the measurement data from the sensor 210 from the sensor data collecting device 220 and outputs the data to each unit in the subsequent stage.

The single observation point trigger processing unit 232 determines a trigger for each observation point on the basis of the measurement data from the sensor 210. The single observation point trigger processing unit 232 outputs a determination result as trigger detection status information for each observation point. The trigger detection status information referred to here is information indicating whether or not a trigger has been detected at an observation point (that is, whether or not a trigger has been detected).

The trigger detection status information corresponds to an example of vibration detection status information. The vibration detection status information is information indicating a vibration detection status at an observation point. In the vibration detection status information, the trigger detection status information indicates a trigger detection status as the vibration detection status.

Each observation point will also be referred to as a single observation point.

The seismic determination unit 233 determines whether or not an earthquake has occurred on the basis of determination results of the triggers at a plurality of observation points. For example, the seismic determination unit 233 determines that an earthquake has occurred in a case where a proportion of observation points at which a trigger derived from the earthquake has been determined is equal to or higher than a predetermined proportion among observation points included in a predetermined range.

In a case where the seismic determination unit 233 determines an earthquake has occurred, the phase inspection unit 234 inspects seismic waves (for example, a P wave, an S wave, and a T wave) at respective phases. An existing method may be used as an inspection method.

In a case where the seismic determination unit 233 determines that an earthquake has occurred, the hypocenter estimation unit 235 predicts the hypocenter on the basis of the inspection results of the phase inspection unit 234. An existing method may be used as the method for predicting the hypocenter.

In a case where the seismic determination unit 233 determines that an earthquake has occurred, the notification processing unit 236 notifies a predefined notification destination of the hypocenter predicted by the hypocenter estimation unit 235 and the tsunami information generated by the tsunami processing device 250.

The data server device 240 stores various data related to seismic observation, such as measurement data from the sensor 210. The data server device 240 stores parameter values for the seismic processing device 230 to perform various processes. For example, in a case where the seismic processing device 230 performs a process in each unit by using a trained model based on machine learning, the data server device 240 may store model parameter values of machine learning results.

The tsunami processing device 250 predicts the presence or absence of the occurrence of a tsunami in a case where the seismic determination unit 233 determines that an earthquake has occurred. A well-known method may be used as a method for the tsunami processing device 250 to predict the presence or absence of the occurrence of a tsunami. The tsunami processing device 250 transmits tsunami information indicating an estimation result of the presence or absence of a tsunami to the notification processing unit 236. As described above, the notification processing unit 236 collectively notifies the notification destination of the hypocenter information and the tsunami information.

The real-time display terminal device 261 displays the measurement data from the sensor 210 in real time.

The maintenance terminal device 262 is a terminal device for maintenance of the seismic processing system 1. For example, a maintenance worker of the seismic processing system 1 uses the maintenance terminal device 262 to update the model parameter values stored in the data server device 240. The maintenance worker of the seismic processing system 1 checks whether or not each of the sensors 210 is operating normally by using the maintenance terminal device 262, and performs maintenance of the sensor 210 as necessary.

The interactive processing terminal device 263 interactively presents a part of processing by the seismic processing system 1 that requires manual processing to a user and receives processing by the user. For example, in a case where the user processes the inspection of the phase inspection unit 234, the interactive processing terminal device 263 may display information for inspection such as a seismic waveform and receive the processing by the user.

Among the constituents of the seismic processing system 1, the seismic determination unit 233 is correlated with the seismic observation device 100. In a case where a plurality of earthquakes have occurred in close proximity in time and position, the seismic observation device 100 not only detects that an earthquake has occurred, but also determines a correspondence relationship concerning which an earthquake has caused a trigger.

The seismic observation device 100 may perform the processing of the seismic determination unit 233. In that case, the seismic processing device 230 may be configured as one device, and the seismic observation device 100 and a part of the seismic processing device 230 may be correlated with each other. Alternatively, the seismic processing device 230 may be configured as a plurality of devices including the seismic observation device 100.

The communication unit 110 of the seismic observation device 100 (FIG. 1) communicates with other devices. For example, the communication unit 110 receives the trigger detection status information for each observation point from the single observation point trigger processing unit 232. The communication unit 110 corresponds to an example of a vibration detection status information acquisition unit.

The display unit 120 includes a display screen such as a liquid crystal panel or a light emitting diode (LED) panel, and displays various images. For example, the display unit 120 displays the trigger detection status information generated by the multidimensionalization unit 191 in two dimensions with a geographical position axis and a time axis.

The operation input unit 130 includes an input device such as a keyboard and a mouse, and accepts user operations.

The storage unit 180 stores various data. The storage unit 180 is configured by using a storage device included in the seismic observation device 100.

The model storage unit 181 stores a trained model. The trained model referred to here is a model obtained through machine learning. The model storage unit 181 may store trained models for some or all of processes by the multidimensionalization unit 191 and the group specifying unit 192. The model storage unit 181 stores a trained model obtained as a result of machine learning.

For example, the model storage unit 181 may store a model including parameters and parameter values obtained through machine learning as a trained model. The model including the parameters may be a neural network such as a convolutional neural network (CNN), but is not limited thereto.

The control unit 190 controls each unit of the seismic observation device 100 to execute various processes. The function of the control unit 190 is executed by a central processing unit (CPU) included in the seismic observation device 100 reading a program from the storage unit 180 and executing the program.

The multidimensionalization unit 191 generates trigger detection status information in two or more dimensions related to a geographical position and a time from the trigger detection status information at each of the plurality of observation points.

The group specifying unit 192 classifies each piece of element information that forms trigger detection status information in two or more dimensions generated by the multidimensionalization unit 191 and indicates a trigger detection status at a certain geographical position and at a certain time as a group for each cause of vibration. That is, the group specifying unit 192 uses trigger detection status information that is multidimensionalized by the multidimensionalization unit 191 to classify trigger detection status information at each observation point and each time, which is an element thereof, as a group for each event (for example, for each earthquake).

<Visualization Method>

One of methods in which the seismic observation device 100 groups triggers by using trigger detection status information in two or more dimensions related to the geographical position and the time will be referred to as a visualization method. In the visualization method, the seismic observation device 100 performs the following steps 11 to 15.

(Step 11)

The multidimensionalization unit 191 generates two-dimensional trigger detection status information related to a geographical position axis to which a plurality of observation points disposed linearly are allocated (a coordinate axis indicating the position on a straight line connecting this plurality of observation points) and a time axis.

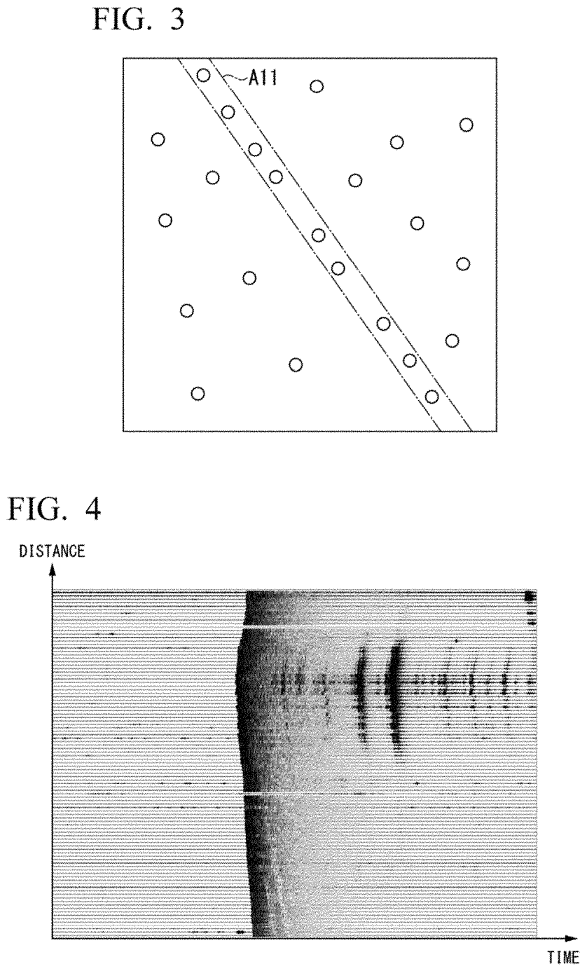

FIG. 3 is a diagram illustrating a disposition example of observation points disposed linearly. In the example in FIG. 3, the observation points are indicated by circles (O). In a region A11, the observation points are disposed substantially linearly.

The multidimensionalization unit 191 allocates the observation points disposed linearly as described above to coordinate axes of the geographical position in the two dimensions of the geographical position and the time. The multidimensionalization unit 191 generates two-dimensional trigger detection status information by displaying a trigger detection status at each time at each allocated observation point in the two-dimensional coordinates. Each time referred to here is, for example, a division into which the time axis is divided for each predetermined unit time period.

FIG. 4 is a diagram illustrating an example of vibration measurement data at each of the observation points disposed linearly. A horizontal axis of the graph in FIG. 4 represents time. A vertical axis represents positions in the longitudinal direction among positions on the straight line where the observation points are disposed (the region A11 in the example in FIG. 3). Each of the observation points disposed linearly is allocated to this vertical axis. The graph of FIG. 4 refers to a 100-trace continuous waveform image published on the website of the National Research Institute for Earth Science and Disaster Prevention (address: http://www.hinet.bosai.go.jp/mtrace/?tm=&pv=&eq=&LANG=ja).

An amplitude for each time at the observation point is illustrated in the horizontal direction (a direction parallel to the time axis) of the position to which the observation point is allocated. As described above, the trigger is a vibration different from the normal vibration (for example, a vibration of which a level is equal to or lower than noise level), and a portion having a large amplitude (black portion) in the graph of FIG. 4 may be regarded as a portion where the trigger is detected.

Alternatively, the multidimensionalization unit 191 may generate a graph plotting a trigger detection status for each observation point and each time instead of a graph for an amplitude for each observation point and each time.

For example, a black plot point may indicate that a trigger has been detected, and a white plot point or nothing may be used to indicate that a trigger has not been detected. The plot indicating that the trigger has been detected will also be referred to as a trigger plot.

(Step 12)

The group specifying unit 192 determines a trigger group.

Here, the group specifying unit 192 classifies triggers for each event (a cause of vibration such as an individual earthquake). The group obtained through this classification is referred to as a trigger group.

The group specifying unit 192 may classify the triggers into groups on the basis of a geometric shape in the two-dimensional trigger detection status information.

Since the observation points are disposed linearly, if a seismic wave spreads concentrically from the hypocenter, the trigger describes a concentric circle or an arc shape on a two-dimensional graph (on the two-dimensional trigger detection status information). In particular, the start time of the trigger (that is, the arrival time of the seismic wave at the observation point) shows a concentric circle or an arc shape. Also in the example in FIG. 4, the sequence of time points when the amplitude becomes large, which corresponds to the start of the trigger, is approximately arc-shaped.

In a case where the distance between the observation points disposed linearly varies, the same shape as when the observation points are allocated to the vertical axis at equal intervals are also shown on the geographical position axis, the observation points being disposed at equal intervals by allocating the observation points at intervals proportional to the intervals between the observation points.

The group specifying unit 192 classifies triggers of which the trigger start times are disposed in an approximately arc shape in the two-dimensional trigger detection status information as the same trigger group. The group specifying unit 192 may automatically perform this classification, or this classification may be manually performed and the group specifying unit 192 associates the triggers with the trigger groups according to a user operation (triggers are classified into trigger groups).

In a case where the group specifying unit 192 automatically performs the above classification, for example, the group specifying unit 192 may select three or more trigger start times for which both a time and the distance between the observation points are within a predetermined range among the trigger start times indicated in the two-dimensional trigger detection status information. The group specifying unit 192 may calculate an arc that passes through all the selected points or an arc that approximates all the selected points. The least squares method may be used for the approximation in this case, but the approximation is not limited to this.

The group specifying unit 192 may classify triggers of which start times are within a predetermined time from the calculated arc as the same trigger group.

In a case of manually classifying triggers into trigger groups, the group specifying unit 192 may calculate an arc passing through start times of triggers selected through a user operation or an arc that approximates start times of the triggers selected through the user operation on a display screen of the two-dimensional trigger detection status information, and display the arc on the screen. The user (a worker of this classification) can determine a start time of a trigger that is hidden by noise and is difficult to see by referring to the displayed arc, and determine whether or not to cause the trigger to be included in a trigger group.

The group specifying unit 192 or a person may classify triggers into trigger groups on the basis of other information such as a vibration waveform in addition to a shape indicated by the trigger start times in the two-dimensional trigger detection status information.

(Step 13)

The multidimensionalization unit 191 predicts the position of the temporary hypocenter. The temporary hypocenter referred to here is the hypocenter that is temporarily set. It is referred to as the temporary hypocenter because the hypocenter is re-predicted through the processing of the hypocenter estimation unit 235 of the seismic processing device 230 (FIG. 2).

The multidimensionalization unit 191 performs an inspection process on a waveform of a vibration at each observation point on the basis of the classification of the triggers into the trigger groups, and predicts the position of the temporary hypocenter on the basis of the inspection result. As a method of predicting the position of the temporary hypocenter, a well-known temporary hypocenter calculation method such as a grid search method may be used.

The multidimensionalization unit 191 may automatically predict the position of the temporary hypocenter. Alternatively, a person may predict the position of the temporary hypocenter, and the multidimensionalization unit 191 may set the position of the temporary hypocenter on the two-dimensional trigger detection status information according to a user operation.

(Step 14)

The multidimensionalization unit 191 generates two-dimensional trigger detection status information related to a geographical position axis to which all the observation points are allocated in the order of distance from the temporary hypocenter and a time axis. As the distance from the temporary hypocenter, a hypocenter distance may be used, or an epicenter distance may be used.

For example, if a time axis is set to the horizontal axis, a geographical position axis is set to the vertical axis, and the observation points are allocated to the geographical position axis in order from closest to the temporary hypocenter from the lower side to the upper side in order (in order of increasing epicenter distance), triggers due to seismic waves from the temporary hypocenter are plotted on an upward-sloping line (or upward-sloping strip shape).

Furthermore, for example, in a case where the distance from the temporary hypocenter to the observation point varies, the distance from a position corresponding to the temporary hypocenter to a position to which the observation point is allocated on the geographical position axis may be proportional to the distance (hypocenter distance) from the temporary hypocenter to the observation point. If a seismic wave from the temporary hypocenter spreads concentrically, triggers due to the seismic wave from this temporary hypocenter are plotted in a linear shape (or rectangular shape).

In a case where the temporary hypocenter is in a shallow position, the same applies even if an epicenter distance to the observation point is used as the distance from the temporary hypocenter to the observation point.

(Step 15)

The group specifying unit 192 determines a trigger group.

As described above, the triggers due to the seismic wave from this temporary hypocenter are plotted on a line (or strip shape) in the two-dimensional graph generated by the multidimensionalization unit 191. Therefore, the group specifying unit 192 classifies the triggers plotted as the same line (or the same strip shape) in the two-dimensional graph generated by the multidimensionalization unit 191 as the same group.

In a case where a plurality of earthquakes that are close in position and time have occurred, the multidimensionalization unit 191 predicts the position of the temporary hypocenter for each earthquake. Next, the multidimensionalization unit 191 and the group specifying unit 192 group triggers for each temporary hypocenter.

The seismic observation device 100 may repeatedly perform the processes from step 13 to step 15.

For example, the seismic observation device 100 may repeatedly perform the processes from step 13 to step 15 until positions of the temporary hypocenters converge. For example, in a case where the multidimensionalization unit 191 performs a process of predicting the position of the temporary hypocenter twice or more in step 13, the distance between the position of the temporary hypocenter obtained in this process and the position of the temporary hypocenter obtained in the previous process may be calculated, and the processes from step 13 to step 15 may be repeatedly performed until the distance is equal to or less than a predetermined threshold value.

In a case where it is determined that the accuracy of trigger grouping in the process in step 12 is sufficiently high, the seismic observation device 100 may suppress (do not perform) the processes from step 13 to step 15. For example, the group specifying unit 192 may evaluate an error between the arc that approximates the start positions of the triggers and the start positions of the triggers in the two-dimensional trigger detection status information for each of the trigger groups obtained in the process in step 12. Next, the group specifying unit 192 may suppress the processes from step 13 to step 15 in a case where this error becomes equal to or less than a predetermined threshold value.

<Encoding Method>

Another method in which the seismic observation device 100 groups triggers by using trigger detection status information in two or more dimensions related to a geographical position and a time will be referred to as an encoding method. In the encoding method, the seismic observation device 100 performs the following processes in steps 21 and 22.

(Step 21)

The multidimensionalization unit 191 generates trigger detection status information in three or more dimensions based on coordinate axes of one or more dimensions in which a plurality of observation points are disposed and a time axis.

The multidimensionalization unit 191 expands trigger detection status information (plots the triggers) in a multidimensional coordinate space having a geographical position axis and a time axis in the same manner as in the case of the visualization method.

On the other hand, the encoding method differs from the case of the visualization method in that a target observation point is not limited to an observation point on one straight line. The encoding method differs from the case of the visualization method in that any order of allocating observation points to the geographical position axis may be employed.

However, the order of allocating observation points to the geographical position axis is fixed according to the encoding method. In particular, in a case where grouping of triggers according to a plot pattern of the triggers is subjected to machine learning according to the encoding method, the order of allocating the observation points to the geographical position axis is the same at the time of learning and at the time of operation.

The encoding method is different from the case of the visualization method in that the multidimensionalization unit 191 may expand the trigger detection status information in a coordinate space in three or more dimensions. For example, the multidimensionalization unit 191 may set the latitude and longitude of the observation point as two axes, and expand the trigger detection status information in a three-dimensional coordinate space including the time axis.

In the encoding method, the multidimensionalization unit 191 may add additional information to the element information (plotted, each observation point and each time trigger) of the trigger detection status information in two or more dimensions. For example, the single observation point trigger processing unit 232 (FIG. 2) classifies the triggers according to an event type (for example, a far-field earthquake, a near-field earthquake, a low frequency earthquake, and an artificial earthquake), and the multidimensionalization unit 191 may add information regarding the event type of a trigger to element information.

By increasing an amount of information to be referred to, it is expected that grouping of each trigger event by the group specifying unit 192 will be performed with higher accuracy.

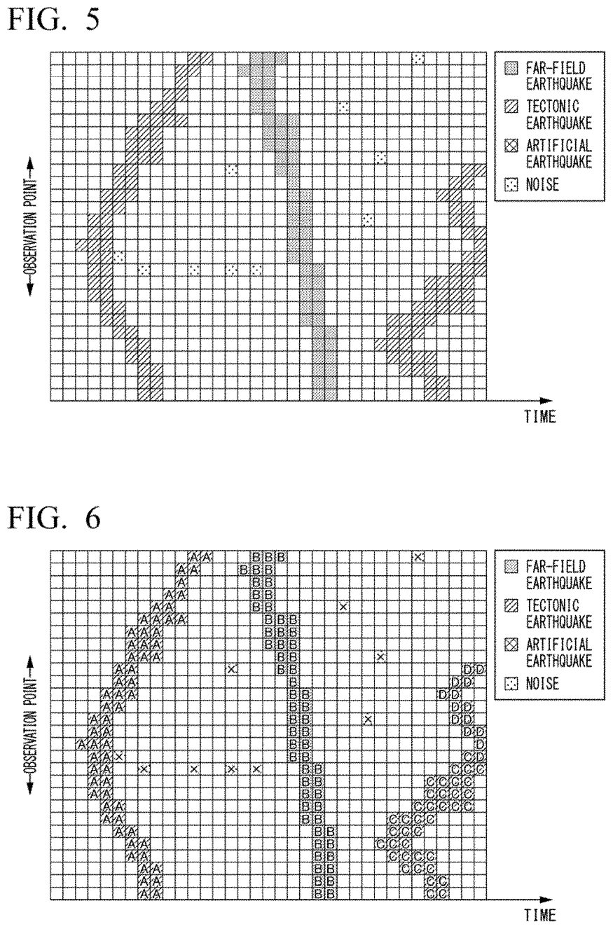

FIG. 5 is a diagram illustrating an example of trigger detection status information in two or more dimensions in the encoding method. A horizontal axis of the graph of FIG. 5 represents time, and observation points are allocated to a vertical axis.

The example in FIG. 5 is an example of a case where, in order to make the drawing easier to see, observation points disposed linearly are allocated to the vertical axis in the order of arrangement. However, in the encoding method, any disposition of the observation points on the geographical position axis (the vertical axis in the example in FIG. 5) may be employed as described above.

In the example in FIG. 5, the type of trigger event (cause of vibration) is illustrated for each piece of element information (for each observation point and for each time).

(Step 22)

The group specifying unit 192 determines a trigger group.

FIG. 6 is a diagram illustrating an example of a trigger group determined by the group specifying unit 192. FIG. 6 illustrates an example of grouping the triggers illustrated in FIG. 5.

In the example in FIG. 6, triggers are generated by four earthquakes such as an earthquake A, an earthquake B, an earthquake C, and an earthquake D, and the group specifying unit 192 classifies events into four groups such as “A”, “B”, and “C”, and “D” for each earthquake. “x” indicates that an event is not an earthquake and thus does not belong to any of the four groups.

In the encoding method, the order in which the observation points are allocated to the geographical position axes is arbitrary, and thus the observation points that are geographically adjacent to each other are not necessarily allocated to be adjacent to each other on the geographical position axes. Therefore, triggers due to the same earthquake are not always represented as a group on the trigger generation status information in the encoding method. As in the group C and the group D in FIG. 6, triggers due to a plurality of earthquakes may be represented as a group.

On the other hand, since the time axis is provided in the trigger generation status information in the encoding method, a difference in arrival time of a seismic wave between the observation points is illustrated in FIG. 6. This arrival time difference indicates a positional relationship between the observation points and a positional relationship between the observation point and the hypocenter, and serves as a clue to group the triggers for each earthquake.

Therefore, a model that receives the input of the trigger generation status information (trigger generation status information in two or more dimensions) in the encoding method and outputs the trigger group may be generated through machine learning. In this model, it is expected that the trigger grouping will be performed with high accuracy by reflecting the seismic wave arrival time difference between the observation points in a grouping rule.

That is, in a case where triggers at a plurality of observation points are caused by the same earthquake, it is expected that statistical information that this positional relationship is often found in the trigger detection status information in two or more dimensions will be reflected in a machine learning result (trained model). On the basis of this reflection, if trigger detection status information in two or more dimensions that is a processing target has this positional relationship, it is determined that the triggers are caused by the same earthquake, or the triggers are caused by the same earthquake as this trigger group, and thus it is expected that grouping of the triggers will be appropriately performed.

In this case, a grouping process performed by the trained model may be regarded as a process of receiving the trigger generation status information in two or more dimensions as an input code and statistically analyzing the input code to determine a trigger group. For this reason, the name of the encoding method is used.

<Combination of Visualization Method and Encoding Method>

The seismic observation device 100 may use both the visualization method and the encoding method in combination, and integrate classification results (grouping results) of both methods. For example, the group specifying unit 192 may integrate a classification result according to the visualization method and a classification result according to the encoding method by performing the following processes in step 31 and step 32.

(Step 31)

The group specifying unit 192 correlates a trigger group in the visualization method with a trigger group in the encoding method.

Classification according to the visualization method and the encoding method before integration will be referred to as temporary classification.

In both the visualization method and the encoding method, a trigger group is required for each observation point and each time. Therefore, the group specifying unit 192 associates the trigger group in the visualization method with the trigger group in the encoding method for each observation point and each time.

(Step 32)

The group specifying unit 192 gives an evaluation to the classification result on the basis of the degree of matching of the classification result (degree of matching of the trigger group).

In a case where the triggers are classified as the same trigger group in the visualization method and the encoding method (that is, in a case where the classification results match each other), the reliability of this classification is considered to be relatively high. Therefore, the group specifying unit 192 gives a high evaluation to the classification result in this case. For example, the group specifying unit 192 adds a relatively large weighting factor (for example, “1”) to the trigger group (trigger group for each observation point and each time) in this case.

On the other hand, in a case where the triggers are classified into different trigger groups in the visualization method and the encoding method, the reliability of this classification is considered to be relatively low. Therefore, the group specifying unit 192 gives a low evaluation to the classification result in this case. For example, the group specifying unit 192 adds a relatively small weighting factor (for example, “0.3”) to the trigger groups (trigger groups for each observation point and each time) in this case.

The weighting factor added to the trigger group by the group specifying unit 192 may be used, for example, when the hypocenter estimation unit 235 (FIG. 2) predicts the hypocenter.

In a case where a correlation between a trigger and an earthquake causing the trigger is correct, using information regarding this trigger (for example, an arrival time of a seismic wave) to predict the hypocenter of the earthquake will increase an amount of information for predicting the hypocenter, and thus it is expected that the estimation accuracy will improve. On the other hand, in a case where a correlation between a trigger and an earthquake causing the trigger is incorrect, and if information regarding this trigger is used to predict the hypocenter of the earthquake, the information will act as noise for the estimation of the hypocenter, and thus it is considered that the estimation accuracy will decrease.

Therefore, the hypocenter estimation unit 235 uses the above weighting factor when predicting the hypocenter to reduce the contribution of the information correlated with a classification result having a low reliability to estimation of the hypocenter. As a result, even in a case where the correlation between the trigger and the earthquake causing the trigger is incorrect, the influence on the estimation accuracy of the hypocenter can be reduced.

In a case where trigger groups as a result of classifying triggers according to the visualization method and the encoding method are different, the group specifying unit 192 may leave only one of the trigger groups. For example, the group specifying unit 192 may delete a trigger group obtained according to the encoding method. Alternatively, the group specifying unit 192 may leave both of the trigger groups. Alternatively, the group specifying unit 192 may delete both of the trigger groups to be excluded from a use target in processes in the subsequent steps.

The group specifying unit 192 may refer to a waveform of a seismic wave in addition to the trigger detection status information when classifying triggers into groups (trigger groups) for each earthquake causing a trigger. In particular, in a case of a far-field earthquake, there is a high possibility that similar waveforms will be observed at a plurality of observation points. It is expected that the group specifying unit 192 will classify triggers when waveforms are similar as the same trigger group by referring to waveforms of seismic waves, and thus will be able to perform classification with relatively high accuracy.

A combination of methods used by the seismic observation device 100 is not limited to the visualization method and the encoding method. The seismic observation device 100 may also use other methods of classifying a trigger as a group for each earthquake causing the trigger in addition to the visualization method and the encoding method or instead of either thereof.

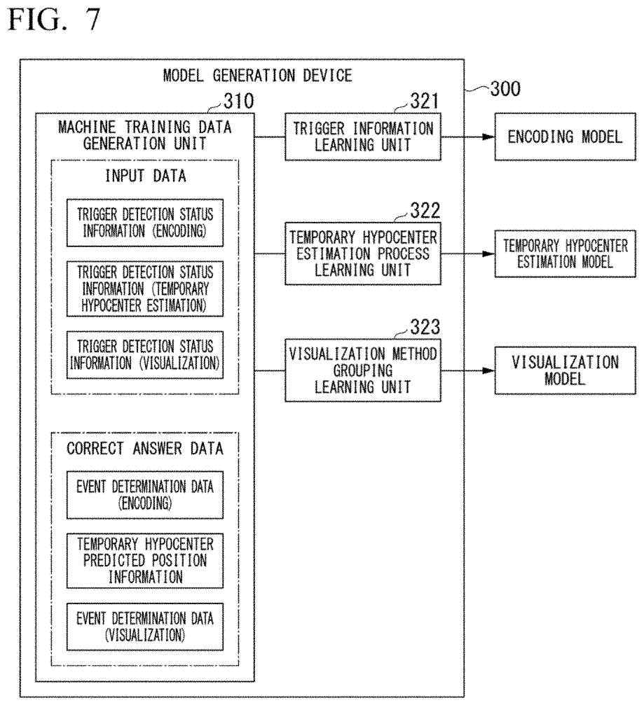

In a case where the process in each unit of the control unit 190 is generated through machine learning, the seismic observation device 100 may execute the machine learning, or a device other than the seismic observation device 100 may perform the machine learning. Hereinafter, a case where a model generation device 300 different from the seismic observation device 100 executes machine learning will be described with reference to FIG. 7.

FIG. 7 is a schematic block diagram illustrating an example of the functional configuration of the model generation device according to the embodiment.

With the configuration illustrated in FIG. 7, the model generation device 300 includes a machine training data generation unit 310, a trigger information learning unit 321, a temporary hypocenter estimation process learning unit 322, and a visualization method grouping learning unit 323.

The model generation device 300 executes machine learning to generate a model used for the process in each unit of the control unit 190.

The model generation device 300 is configured by using a computer such as a workstation or a mainframe.

The machine training data generation unit 310 generates supervised machine training data. Specifically, the machine training data generation unit 310 acquires trigger detection status information (encoding), trigger detection status information (temporary hypocenter estimation), and trigger detection status information (visualization) as input data to a model.

The trigger detection status information (encoding) is trigger detection status information in two or more dimensions generated by the multidimensionalization unit 191 according to the encoding method.

The trigger detection status information (temporary hypocenter estimation) is data in which trigger detection status information at observation points located on other than the straight line for determining which side of the straight line the temporary hypocenter is located on is added to the two-dimensional trigger detection status information at the observation points disposed linearly, which is generated by the multidimensionalization unit 191 in order to predict the temporary hypocenter according to the visualization method.

The trigger detection status information (visualization) is two-dimensional trigger detection status information that is generated by the multidimensionalization unit 191 in order to determine a trigger group according to the visualization method and in which the observation points are allocated to the geographical position axes according to the distance from the temporary hypocenter.

The machine training data generation unit 310 acquires event determination data (encoding), temporary hypocenter predicted position information, and event determination data (visualization) as correct answer data.

The event determination data (encoding) is information indicating a trigger group corresponding to a correct answer for the trigger detection status information (encoding).

The temporary hypocenter predicted position information is information indicating the position of the temporary hypocenter corresponding to a correct answer for the trigger detection status information (temporary hypocenter estimation).

The event determination data (visualization) is information indicating a trigger group corresponding to a correct answer for the trigger detection status information (visualization).

The machine training data generation unit 310 generates training data that is a combination of the input data and the correct answer data for each learning unit (that is, the trigger information learning unit 321, the temporary hypocenter estimation process learning unit 322, and the visualization method grouping learning unit 323) and provides the training data for machine learning.

The machine training data generation unit 310 generates a combination of trigger detection status information (encoding) and event determination data (encoding) corresponding thereto as training data for the trigger information learning unit 321.

The machine training data generation unit 310 generates a combination of trigger detection status information (temporary hypocenter estimation) and temporary hypocenter predicted position information corresponding thereto as training data for the temporary hypocenter estimation process learning unit 322.

The machine training data generation unit 310 generates a combination of trigger detection status information (visualization) and event determination data (visualization) corresponding thereto as training data for the visualization method grouping learning unit 323.

The trigger information learning unit 321 adjusts a parameter value (learning parameter value) of an encoding model through machine learning. The encoding model is a model for performing processes according to the encoding method. The encoding model receives the input of the trigger detection status information in two or more dimensions in the encoding method, and outputs a classification result of classifying triggers into groups (trigger groups) for each earthquake.

The temporary hypocenter estimation process learning unit 322 adjusts a parameter value (learning parameter value) of a temporary hypocenter estimation model through machine learning. The temporary hypocenter estimation model is a model for predicting the position of the temporary hypocenter. The temporary hypocenter estimation model receives the input of the two-dimensional trigger detection status information at the observation points disposed linearly and the trigger detection status information at the observation points located on other than the straight line, and outputs an predicted position of the temporary hypocenter.

However, as described above, a person may predict the position of the temporary hypocenter. In this case, it is not necessary for the model generation device 300 to include the temporary hypocenter estimation process learning unit 322.

The visualization method grouping learning unit 323 adjusts a parameter value (learning parameter value) of a visualization model through machine learning. The visualization model is a model for classifying triggers into groups for each earthquake (trigger group) according to the visualization method. The visualization model receives the input of the two-dimensional trigger detection status information in which the observation points are allocated to the geographical position axis according to the distance from the temporary hypocenter, and outputs a classification result of classifying triggers into groups (trigger groups) for each earthquake.

As described above, the communication unit 110 acquires the vibration detection status information at each of the plurality of observation points. The multidimensionalization unit 191 generates vibration detection status information in two or more dimensions related to a geographical position and a time on the basis of the vibration detection status information at each of the plurality of observation points. The group specifying unit 192 classifies each piece of the element information as a group for each cause of vibration. The element information referred to here is information that forms vibration detection status information in two or more dimensions generated by the multidimensionalization unit 191 and indicates a vibration detection status at a certain geographical position and at a certain time.

As a result, the seismic observation device 100 can use trigger generation time information in order to obtain a correspondence relationship between the trigger and an earthquake that caused the trigger, and can thus use a relatively large amount of information.

In particular, a seismic wave arrival time difference between observation points can be calculated from the trigger generation time information, and thus a positional relationship between the observation points is shown. It is expected that the seismic observation device 100 will be able to group triggers with relatively high accuracy by using this information.

The multidimensionalization unit 191 generates two-dimensional vibration detection status information related to the geographical position axis to which observation points are allocated in the order of the distance from the temporarily set hypocenter and the time axis.

In this two-dimensional vibration detection status information, triggers caused by the same earthquake are shown in a linear or strip shape. It is expected that the group specifying unit 192 will be able to group the triggers with relatively high accuracy on the basis of this information.

The multidimensionalization unit 191 generates two-dimensional vibration detection status information related to a coordinate axis indicating the position on a straight line connecting a plurality of observation points disposed linearly and a time axis, and temporarily sets the hypocenter by using the vibration detection status information. In this two-dimensional vibration detection status information, the direction of the temporary hypocenter is geometrically shown. It is expected that the multidimensionalization unit 191 will be able to predict the position of the temporary hypocenter relatively easily by using this information.

The multidimensionalization unit 191 generates vibration detection status information in two or more dimensions based on coordinate axes of one or more dimensions in which a plurality of observation points are disposed and a time axis.

In this vibration detection status information in two or more dimensions, there is a correlation between a code pattern indicated by a trigger and a correspondence relationship between the trigger and an earthquake that has caused the trigger. In particular, since the time axis is provided in the trigger generation status information in the encoding method, a seismic wave arrival time difference between the observation points is shown in the graph. This arrival time difference indicates a positional relationship between the observation points and a positional relationship between the observation point and the hypocenter. It is expected that the group specifying unit 192 will be able to group triggers with relatively high accuracy on the basis of this information.

The multidimensionalization unit 191 acquires type information indicating the type of cause of vibration of a vibration indicated by the element information, and generates vibration detection status information in two or more dimensions including the acquired type information.

It is expected that the group specifying unit 192 will be able to use a relatively large amount of information by grouping triggers by using this information and can thus perform the grouping with relatively high accuracy.

The group specifying unit 192 adds evaluation information for the classification result of the element information into the groups on the basis of a matching status of a plurality of temporary classifications in which the element information is classified into the groups.

It is expected that the position of the hypocenter will be able to be predicted with relatively high accuracy by reflecting this evaluation information in the hypocenter position estimation.

According to the seismic observation device 100, it is possible to evaluate a temporal relationship and a distance relationship of triggers, and thus the triggers caused by a plurality of close-range earthquakes can be separated for each close-range earthquake.

It is possible to eliminate impossible correlation between a trigger and an earthquake that has caused the trigger by performing statistical processing by using machine learning in the seismic observation device 100.

According to the seismic observation device 100, even in a case where different types of earthquakes are mixed, the earthquakes that have caused triggers can be ascertained separately if the earthquakes can be separated by trigger levels.

Consequently, the seismic observation device 100 can avoid ascertaining a plurality of earthquakes as one earthquake, and can thus avoid, for example, a decrease in the accuracy of hypocenter estimation.

By performing machine learning on determination of a correspondence relationship between a trigger and an earthquake that has caused the trigger in the seismic observation device 100, it is possible to perform determination close to determination performed by a person. Therefore, according to the seismic observation device 100, a probability of erroneous determination of a correspondence relationship between a trigger and an earthquake that has caused the trigger is low, and thus, the position of the hypocenter can be predicted with relatively high accuracy.

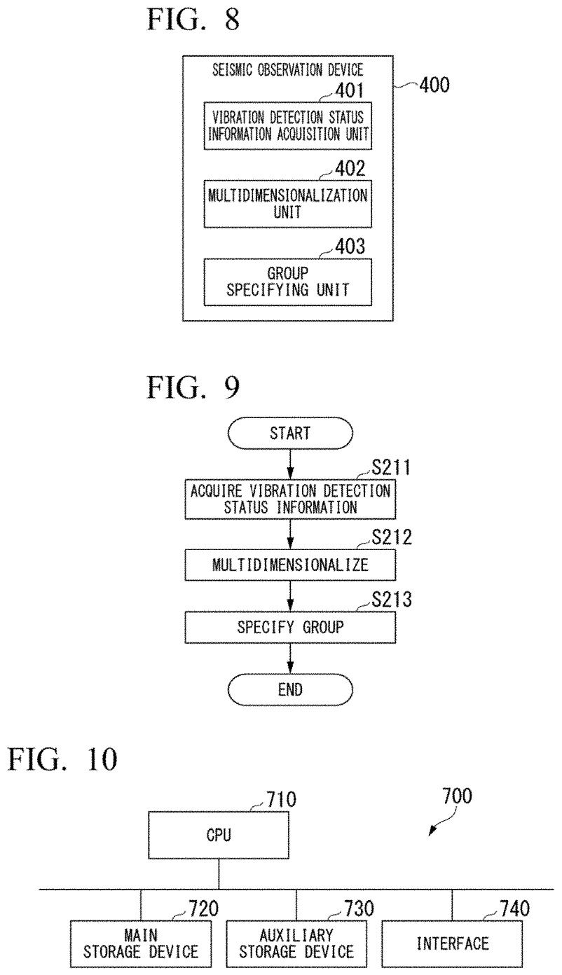

Next, a configuration of an embodiment of the minimum configuration the present invention will be described with reference to FIGS. 8 and 9.

FIG. 8 illustrates a seismic observation device according to an embodiment of the minimum configuration. A seismic observation device 400 illustrated in FIG. 8 includes a vibration detection status information acquisition unit 401, a multidimensionalization unit 402, and a group specifying unit 403.

With this configuration, the vibration detection status information acquisition unit 401 acquires vibration detection status information at each of a plurality of observation points. The multidimensionalization unit 402 generates vibration detection status information in two or more dimensions related to a geographical position and a time on the basis of the vibration detection status information at each of the plurality of observation points. The group specifying unit 403 classifies element information that forms the vibration detection status information in two or more dimensions and each of which indicates a vibration detection status at a certain geographical position and a certain time into groups for each cause of vibration.

Consequently, the seismic observation device 400 can use vibration generation time information in order to obtain a correspondence relationship between a vibration and an earthquake that has caused the vibration, and can thus use a relatively large amount of information.

In particular, a seismic wave arrival time difference between observation points can be calculated from the vibration generation time information, and thus a positional relationship between the observation points is shown. It is expected that the seismic observation device 400 will be able to obtain a correspondence relationship between a vibration and an earthquake that has caused the vibration with relatively high accuracy by using this information.

FIG. 9 illustrates a processing procedure in a seismic observation method according to an embodiment of the minimum configuration.

A process illustrated in FIG. 9 includes a vibration detection status information acquisition step (step S211) of acquiring vibration detection status information at each of a plurality of observation points; a multidimensionalization step (step S212) of generating vibration detection status information in two or more dimensions related to a geographical position and a time on the basis of the vibration detection status information at each of the plurality of observation points; and a group specifying step (step S213) of classifying element information that forms the vibration detection status information in two or more dimensions and each piece of which indicates a vibration detection status at a certain geographical position and a certain time into groups for each cause of vibration.

According to the process in FIG. 9, the vibration generation time information can be used in order to obtain a correspondence relationship between a vibration and an earthquake that has caused the vibration, and thus a relatively large amount of information can be used.

In particular, a seismic wave arrival time difference between observation points can be calculated from the vibration generation time information, and thus a positional relationship between the observation points is shown. In the process of FIG. 9, it is expected that it will be possible to obtain a correspondence relationship between a vibration and an earthquake that has caused the vibration with relatively high accuracy by using this information.

FIG. 10 is a schematic block diagram illustrating a configuration of a computer according to at least one of the above embodiments.

In the configuration illustrated in FIG. 10, a computer 700 includes a central processing unit (CPU) 710, a main storage device 720, an auxiliary storage device 730, and an interface 740.

Any one or more of the seismic observation device 100, the seismic processing device 230, the model generation device 300, and the seismic observation device 400 may be mounted on the computer 700. In that case, an operation of each of the above processing units is stored in the auxiliary storage device 730 in the form of a program. The CPU 710 reads the program from the auxiliary storage device 730, loads the program to the main storage device 720, and executes the above process according to the program. The CPU 710 secures a storage area corresponding to each of the above storage units in the main storage device 720 according to the program.

In a case where the seismic observation device 100 is mounted on the computer 700, operations of the control unit 190 and each unit thereof are stored in the auxiliary storage device 730 in the form of a program. The CPU 710 reads the program from the auxiliary storage device 730, loads the program to the main storage device 720, and executes the processes of the control unit 190 and each unit thereof according to the program.

The CPU 710 secures storage areas corresponding to the storage unit 180 and each unit thereof in the main storage device 720 according to the program. The communication performed by the communication unit 110 is executed by the interface 740 having a communication function and performing communication under the control of the CPU 710. The function of the display unit 120 is executed by the interface 740 having a display screen and performing display under the control of the CPU 710. The function of the operation input unit 130 is executed by the interface 740 having an input device and accepting a user operation under the control of the CPU 710.

In a case where the seismic processing device 230 is mounted on the computer 700, an operation of each of the single observation point trigger processing unit 232, the seismic determination unit 233, the phase inspection unit 234, the hypocenter estimation unit 235, and the notification processing unit 236 is stored in the auxiliary storage device 730 in the form of a program. The CPU 710 reads the program from the auxiliary storage device 730, loads the program to the main storage device 720, and executes the process in each of the units according to the program. The communication performed by the receiving unit 231 is executed by the interface 740 having a communication function and performing communication under the control of the CPU 710.

In a case where the model generation device 300 is mounted on the computer 700, an operation of each of the machine training data generation unit 310, the trigger information learning unit 321, the temporary hypocenter estimation process learning unit 322, and the visualization method grouping learning unit 323 is stored in the auxiliary storage device 730 in the form of a program. The CPU 710 reads the program from the auxiliary storage device 730, loads the program to the main storage device 720, and executes the process in each of the units according to the program.

In a case where the seismic observation device 400 is mounted on the computer 700, an operation of each of the multidimensionalization unit 402 and the group specifying unit 403 is stored in the auxiliary storage device 730 in the form of a program. The CPU 710 reads the program from the auxiliary storage device 730, loads the program to the main storage device 720, and executes the process in each of the units according to the program.

The data acquisition performed by the vibration detection status information acquisition unit 401 is executed by the interface 740 having a communication function and performing communication under the control of the CPU 710.

A program for executing all or some of the processes performed by the seismic observation device 100, the seismic processing device 230, the model generation device 300, and the seismic observation device 400 may be recorded on a computer-readable recording medium, and the process in each unit may be performed by reading the program recorded on the recording medium into a computer system and executing the program. The term “computer system” as used herein includes an OS or hardware such as peripheral devices.

The “computer-readable recording medium” refers to a portable medium such as a flexible disk, a magneto-optical disk, a ROM, or a CD-ROM, or a storage device such as a hard disk built into a computer system. The above program may be a program for realizing some of the above functions, and may be a program for realizing the above functions in combination with a program already recorded in the computer system.

Although the embodiments of the present invention have been described in detail with reference to the drawings, a specific configuration is not limited to these embodiments, and includes designs and the like within the scope without departing from the concept of the present invention.

Priority is claimed on Japanese Patent Application No. 2019-150631, filed Aug. 20, 2019, the content of which is incorporated herein by reference.

### INDUSTRIAL APPLICABILITY

The present invention can be applied to a seismic observation device that measures a seismic intensity of an earthquake and predicts the hypocenter, and it is possible to use a relatively large amount of information in order to obtain a correspondence relationship between an observed vibration and an earthquake that has caused the vibration.

### DESCRIPTION OF REFERENCE SYMBOLS

1 Seismic processing system
100, 400 Seismic observation device
110 Communication unit
120 Display unit
130 Operation input unit
180 Storage unit
181 Model storage unit
190 Control unit
191, 402 Multidimensionalization unit
192, 403 Group specifying unit
210 Sensor
220 Sensor data collecting device
230 Seismic processing device
231 Receiving unit
232 Single observation point trigger processing unit
233 Seismic determination unit
234 Phase inspection unit
235 Hypocenter estimation unit
236 Notification processing unit
240 Data server device
250 Tsunami processing device
261 Real-time display terminal device
262 Maintenance terminal device
263 Interactive processing terminal device
300 Model generation device
310 Machine training data generation unit
321 Trigger information learning unit
322 Temporary hypocenter estimation process learning unit
401 Vibration detection status information acquisition unit

1. A seismic observation device comprising:
a memory storing instructions; and
one or more processors connected to the memory and configured to execute the instructions to:
acquire vibration detection status information at each of a plurality of observation points;
generate vibration detection status information in two or more dimensions related to a geographical position and a time on the basis of the vibration detection status information at each of the plurality of observation points; and
classify element information that forms the vibration detection status information in two or more dimensions and each piece of which indicates a vibration detection status at a certain geographical position and a certain time into groups for each cause of vibration.

2. The seismic observation device according to claim 1,
wherein the one or more processors are configured to further execute the instructions to generate two-dimensional vibration detection status information related to a geographical position axis to which the observation points are allocated in an order of distance from a temporarily set hypocenter and a time axis.

3. The seismic observation device according to claim 2,
wherein the one or more processors are configured to further execute the instructions to generate two-dimensional vibration detection status information related to a coordinate axis indicating a position on a straight line connecting the plurality of observation points disposed linearly and a time axis, and temporarily sets the hypocenter by using the vibration detection status information.

4. The seismic observation device according to claim 1,
wherein the one or more processors are configured to further execute the instructions to generate vibration detection status information in two or more dimensions related to coordinate axes of one or more dimensions in which the plurality of observation points are disposed and a time axis.

5. The seismic observation device according to claim 4,
wherein the one or more processors are configured to further execute the instructions to:
acquire type information indicating the type of cause of vibration of a vibration indicated by the element information, and
generate the vibration detection status information in two or more dimensions including the type information.

6. The seismic observation device according to claim 1,
wherein the one or more processors are configured to further execute the instructions to add evaluation information for a classification result of the element information into the groups on the basis of a matching status of a plurality of temporary classifications in which the element information is classified into the groups.

7. A seismic observation method comprising:
acquiring vibration detection status information at each of a plurality of observation points;
generating vibration detection status information in two or more dimensions related to a geographical position and a time on the basis of the vibration detection status information at each of the plurality of observation points; and
classifying element information that forms the vibration detection status information in two or more dimensions and each piece of which indicates a vibration detection status at a certain geographical position and a certain time into groups for each cause of vibration.

8. A non-transitory recording medium for recording a seismic observation program causing a computer to:
acquire vibration detection status information at each of a plurality of observation points;
generate vibration detection status information in two or more dimensions related to a geographical position and a time on the basis of the vibration detection status information at each of the plurality of observation points; and
classify element information that forms the vibration detection status information in two or more dimensions and each piece of which indicates a vibration detection status at a certain geographical position and a certain time into groups for each cause of vibration.
